(19) United States
(12) Patent Application Publication
(10) Pub. No.: US 2011/0024137 A1
(43) Pub. Date: Feb. 3, 2011

(54) UNIFIED FIRE EXTINGUISHING SYSTEM FOR TURBINE BEARING IN POWER PLANT

(75) Inventor: Jin Soo MA, Yongin (KR)

Correspondence Address: Jason Y. Pahng and Associates, LLC, 12178 Bridgend Run, Fairfax, VA, 22030, US

(73) Assignee: KOREA POWER ENGINEERING COMPANY, INC., Yongin (KR)

(21) Appl. No.: 12/843,852

(22) Filed: Jul. 26, 2010

(30) Foreign Application Priority Data
Jul. 30, 2009 (KR) 10-2009-0069970

(51) Int. Cl. A62C 3/00

(52) U.S. Cl. 169/54

(57) ABSTRACT

A unified fire extinguishing system for a turbine bearing in a power plant, the system puts out a fire that breaks out due to overheating of a lubricant oil due to friction between a turbine shaft disposed inside a turbine bearing housing in the power plant and a turbine bearing that rotatably supports the turbine shaft, and the system includes: a spray nozzle separate from the turbine bearing and disposed inside the turbine bearing housing; and a connection pipe having one end connected to the spray nozzle and the other end connected to a sprinkler pipe, wherein, when a fire breaks out in the turbine bearing housing due to overheating of the lubricant oil, a fire extinguishing fluid supplied from the sprinkler pipe for putting out a fire passes through the connection pipe and is discharged into the turbine bearing via the spray nozzle.

### CROSS-REFERENCE TO RELATED PATENT APPLICATION

This application claims the benefit of Korean Patent Application No. 10-2009-0069970, filed on Jul. 30, 2009, in the Korean Intellectual Property Office, the disclosure of which is incorporated herein in its entirety by reference.

### BACKGROUND OF THE INVENTION

1. Field of the Invention

The present invention relates to a unified fire extinguishing system for a turbine bearing in a power plant, and more particularly, to a unified fire extinguishing system for a turbine bearing in a power plant having an improved structure in which a fire that breaks out at a turbine bearing is efficiently put out.

2. Description of the Related Art

FIG. 1 is a partial cross-sectional view of a conventional fire extinguishing system for a turbine bearing 102 in a power plant, and FIG. 2 is an image showing use of the conventional fire extinguishing system illustrated in FIG. , and FIG. 3 is an image showing the scene of a fire on which the conventional fire extinguishing system of FIG. 1 is used. Referring to FIGS. 1, 2, and 3, the conventional fire extinguishing system for the turbine bearing 102 in a power plant is used to put out a fire that breaks out due to overheating of a lubricant oil due to friction between a turbine shaft 101 and the turbine bearing 102. The conventional fire extinguishing system for the turbine bearing 102 in a power plant includes a spray nozzle 104 disposed outside a turbine bearing housing 103.

The turbine shaft 101 is disposed inside the turbine bearing housing 103, and the turbine bearing 102 rotatably supports the turbine shaft 101, and the spray nozzle 104 is connected to a sprinkler pipe 106 via a connection pipe 105 and injects a fluid that is supplied from the sprinkler pipe 106 to an outside of the turbine bearing housing 103, in order to put out a fire.

However, the conventional fire extinguishing system for the turbine bearing 102 in a power plant having the above structure has the following problems.

In the prior art, although a fire due to overheating of a lubricant oil due to friction between the turbine shaft 101 and the turbine bearing 102 breaks out in the turbine bearing housing 103, the spray nozzle 104 is disposed outside the turbine bearing housing 103 in consideration of convenience of installation or the like.

Thus, the fire that breaks out in the turbine bearing housing 103 cannot be smoothly put out at an initial stage and results in a large-scale fire, as illustrated in FIG. 3. As a result, components for a turbine in a power plant, such as the turbine bearing 102 and the turbine shaft 101, are damaged, and time and costs for putting out the fire are increased.

### SUMMARY OF THE INVENTION

The present invention provides a unified fire extinguishing system for a turbine bearing in a power plant having an improved structure in which a fire that breaks out in a turbine bearing housing due to friction between a turbine bearing and a lubricant oil can be smoothly put out at an initial stage and thus a large-scale fire can be prevented from occurring.

According to an aspect of the present invention, there is provided a unified fire extinguishing system for a turbine bearing in a power plant, for putting out a fire that breaks out due to overheating of a lubricant oil due to friction between a turbine shaft disposed inside a turbine bearing housing in the power plant and a turbine bearing that rotatably supports the turbine shaft, the system including: a spray nozzle separate from the turbine bearing and disposed inside the turbine bearing housing; and a connection pipe having one end connected to the spray nozzle and the other end connected to a sprinkler pipe, wherein, when a fire breaks out in the turbine bearing housing due to overheating of the lubricant oil, a fire extinguishing fluid supplied from the sprinkler pipe for putting out a fire passes through the connection pipe and is discharged into the turbine bearing via the spray nozzle.

The connection pipe may include a flexible pipe.

The connection pipe may be disposed outside the turbine bearing housing, and one end of the connection pipe may be connected to the spray nozzle by using a through hole of the turbine bearing housing.

The spray nozzle and the connection pipe may be screw-connected to each other so that the spray nozzle and the connection pipe are easily combined to each other and are easily separated from each other.

### BRIEF DESCRIPTION OF THE DRAWINGS

The above and other features and advantages of the present invention will become more apparent by describing in detail exemplary embodiments thereof with reference to the attached drawings in which:

FIG. 1 is a partial cross-sectional view of a conventional fire extinguishing system for a turbine bearing in a power plant;

FIG. 2 is an image showing use of the conventional fire extinguishing system illustrated in FIG. 1;

FIG. 3 is an image showing the scene of a fire on which the conventional fire extinguishing system of FIG. 1 is used;

FIG. 4 is a partial cross-sectional view of a unified fire extinguishing system for a turbine bearing in a power plant, according to an embodiment of the present invention; and

FIG. 5 is a partial cross-sectional view of a unified fire extinguishing system for a turbine bearing in a power plant, according to another embodiment of the present invention.

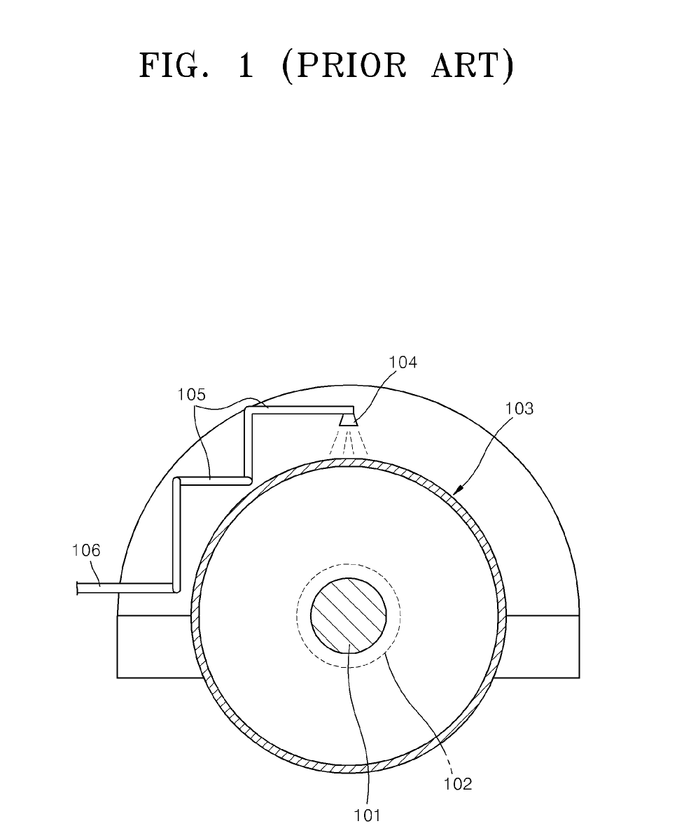

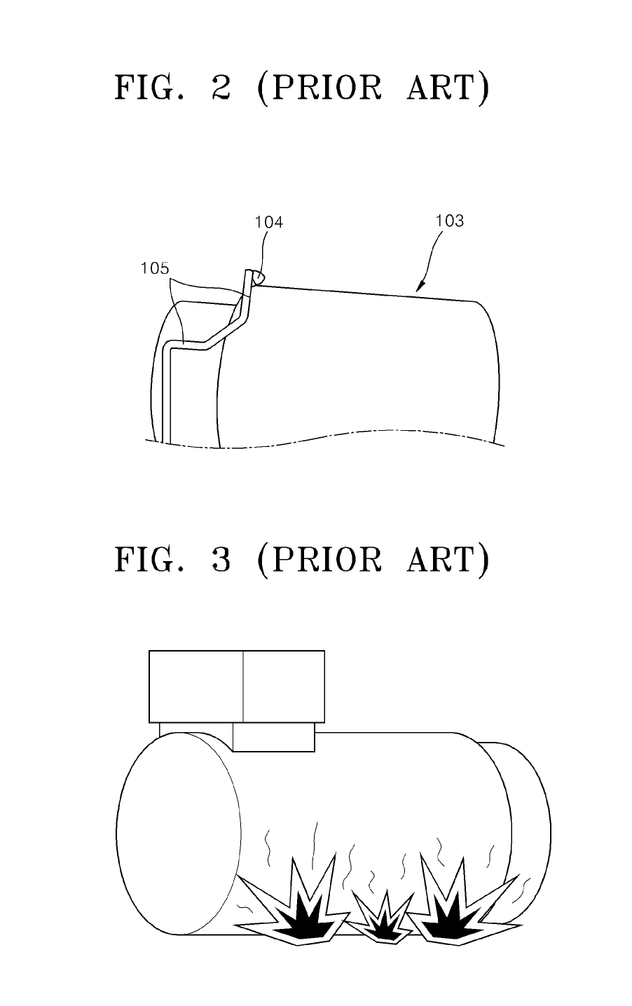

### DETAILED DESCRIPTION OF THE INVENTION

The present invention will now be described more fully with reference to the accompanying drawings, in which exemplary embodiments of the invention are shown.

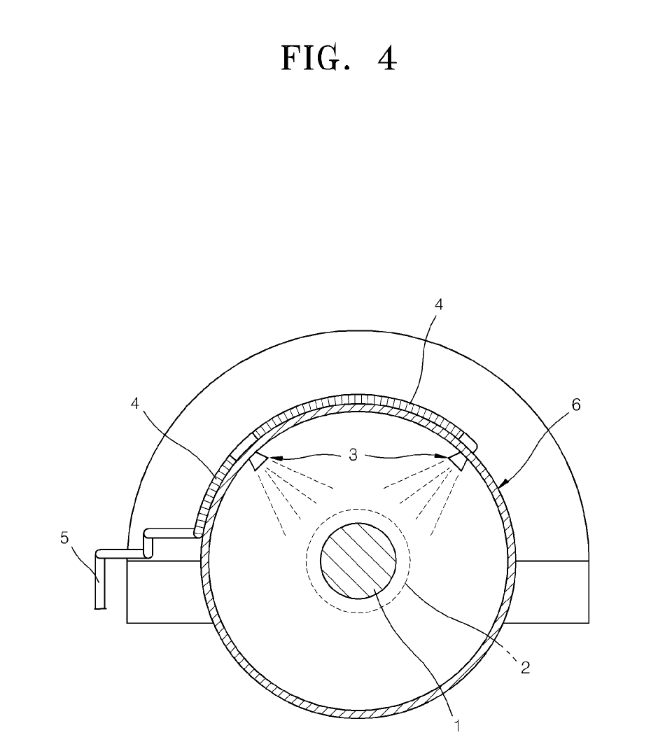

FIG. 4 is a partial cross-sectional view of a unified fire extinguishing system for a turbine bearing 2 in a power plant, according to an embodiment of the present invention.

Referring to FIG. 4, the unified fire extinguishing system for the turbine bearing 2 in a power plant, according to the current embodiment of the present invention, is used to put out a fire that breaks out due to overheating of a lubricant oil due to friction between a turbine shaft 1 disposed inside a turbine bearing housing 6 and the turbine bearing 2 that rotatably supports the turbine shaft 1. The unified fire extinguishing system for the turbine bearing 2 in a power plant includes two spray nozzles 3 and two connection pipes 4. Although two spray nozzles 3 and two connection pipes 4 are included in the present embodiment, the present invention is not limited thereto and the present embodiment may include at least one spray nozzle 3 and at least one connection pipe 4.

The spray nozzle 3 is separate from the turbine bearing 2 and is disposed in the turbine bearing housing 6. In the present embodiment, the spray nozzle 3 is connected to a sprinkler pipe 5 via the connection pipe 4. Thus, a fire extinguishing fluid for putting out a fire supplied from the sprinkler pipe 5 passes through the connection pipe 4 and is directly discharged into the turbine bearing 2 via the spray nozzle 3. The spray nozzle 3 operates according to signals transmitted from a sensing unit (not shown) that senses that a fire has broken out in the turbine bearing 2, and according to control signals of a controller (not shown) based on the signals transmitted from the sensing unit. An operating principle of the spray nozzle 3 is obvious to one of ordinary skill in the art and thus, a description thereof will not be provided here.

The spray nozzle 3 discharges a fire extinguishing fluid for putting out a fire directly into the turbine bearing 2 at an initial stage where the fire has broken out in the turbine bearing 2, prevents a large-scale fire from occurring, and remarkably reduces time and costs for putting out the fire.

One end of the connection pipe 4 is connected to the spray nozzle 3, and the other end thereof is connected to the sprinkler pipe 5. The connection pipe 4 provides a moving path via which the fluid supplied from the sprinkler pipe 5 for putting out the fire is transported to the spray nozzle 3.

In the present embodiment, a flexible pipe is used as the connection pipe 4. Thus, the efficiency of installing the connection pipe 4 may be increased, compared to installation of a rigid pipe. Also, when components disposed in the turbine bearing housing 6 are replaced with other ones, a range where the turbine bearing housing 6 and the connection pipe 4 interfere with each other may be further reduced so that the efficiency of replacing components may also be improved.

The connection pipe 4 is screw-connected to the spray nozzle 3 via a through hole of the turbine bearing housing 6 so that the connection pipe 4 may be easily combined to the spray nozzle 3 and may be easily separated therefrom.

Also, the connection pipe 4 is disposed outside the turbine bearing housing 6, unlike the spray nozzle 3 disposed inside the turbine bearing housing 6, and one end of the connection pipe 4 is connected to the spray nozzle 3 by using the through hole of the turbine bearing housing 6.

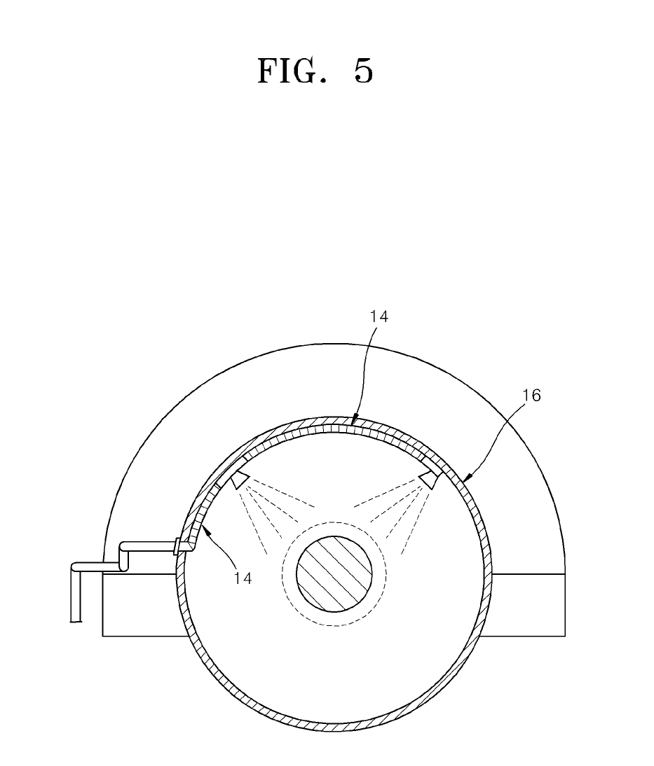

In the present embodiment, compared to another embodiment of the present invention illustrated in FIG. 5, i.e., compared to a structure in which the connection pipe 14 is disposed inside the turbine bearing housing 16 together with the spray nozzle 3, the efficiency of connecting the sprinkler pipe 5 and the spray nozzle 3 may be improved.

FIG. 5 is a partial cross-sectional view of a unified fire extinguishing system for a turbine bearing in a power plant, according to another embodiment of the present invention.

Unlike in FIG. 4, referring to FIG. 5, a connection pipe 14 may be disposed inside a turbine bearing housing 16.

As described above, in a unified fire extinguishing system for a turbine bearing in a power plant, according to the present invention, a fire that breaks out due to overheating of a lubricant oil due to friction between a turbine bearing disposed in a turbine bearing housing and a turbine shaft may be put out by discharging a fire extinguishing fluid that is used to put out a fire and filled in the turbine bearing housing, directly into the turbine bearing, so that the efficiency of putting out the fire that breaks out in the turbine bearing may be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A unified fire extinguishing system for a turbine bearing in a power plant, for putting out a fire that breaks out due to overheating of a lubricant oil due to friction between a turbine shaft disposed inside a turbine bearing housing in the power plant and a turbine bearing that rotatably supports the turbine shaft, the system comprising:
a spray nozzle separate from the turbine bearing and disposed inside the turbine bearing housing; and
a connection pipe having one end connected to the spray nozzle and the other end connected to a sprinkler pipe,
wherein, when a fire breaks out in the turbine bearing housing due to overheating of the lubricant oil, a fire extinguishing fluid supplied from the sprinkler pipe for putting out a fire passes through the connection pipe and is discharged into the turbine bearing via the spray nozzle.

2. The system of claim 1, wherein the connection pipe comprises a flexible pipe.

3. The system of claim 1, wherein the connection pipe is disposed outside the turbine bearing housing, and one end of the connection pipe is connected to the spray nozzle by using a through hole of the turbine bearing housing.

4. The system of claim 1, wherein the spray nozzle and the connection pipe are screw-connected to each other so that the spray nozzle and the connection pipe are easily combined to each other and are easily separated from each other.
